(19) United States
(12) Patent Application Publication
(10) Pub. No.: US 2019/0287071 A1
(43) Pub. Date: Sep. 19, 2019

(54) BEACONIZED TIME ENTRY SYSTEM

(71) Applicant: ORACLE INTERNATIONAL CORPORATION, Redwood Shores, CA (US)

(72) Inventors: Sushmitha SUNDAR, Bangalore (IN); Manish SOMANI, Parker, CO (US); Rahul DUTTA, Bangalore (IN)

(21) Appl. No.: 15/923,479

(22) Filed: Mar. 16, 2018

(51) Int. Cl. G06Q 10/10; G06F 17/30

(52) U.S. Cl. CPC G06Q 10/1091; G06F 17/30864; G06Q 10/1097

(57) ABSTRACT

Systems, methods, and other embodiments associated with beaconized time entry are described. In one embodiment, a method includes controlling a wireless receiver of a computing device to listen for beacon signals transmitted by beacon devices located at different locations within a work site. The example method may also include evaluating a first beacon signal from a first beacon device and a second beacon signal from a second beacon device to determine that the first beacon device is located at a first location and that the second beacon device is located at a second location. The example method may also include determining whether the computing device entered the work site or exited the work site based upon a sequence of receiving the beacon signals and the relative position of the locations of the beacon devices. The example method may also include transmitting a time entry command to a remote computing system.

### BACKGROUND

Many places of employment track employee work hours. Existing technological processes for tracking employee work hours can employ a manual time entry system where employees can manually enter time entries through a user interface provided by a computer system. Unfortunately, manual time entry can be error prone and imprecise such as where a user enters incorrect time entry data or forgets to enter time entry data. Other existing technological processes can utilize a radio frequency identification (RFID) system to control security access of employees at various locations in a building. In particular, an employee is required to carry an RFID tag that is scanned when the user attempts to pass a security point in a work site. Because a single scanner is used for identifying the RFID tag, the RFID system is unable to determine whether the employee entered or exited the work site, but just that the RFID tag was scanned. Thus, existing technological processes for tracking employee work hours suffer from technological problems of being error prone, imprecise, and/or requiring employees to carry additional RFID tags.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates an embodiment of a system associated with beaconized time entry.

FIG. 2 illustrates an embodiment of a method associated with beaconized time entry.

FIG. 3A illustrates an embodiment of a system associated with beaconized time entry, where a computing device receives a beacon signal from a first beacon.

FIG. 3B illustrates an embodiment of a system associated with beaconized time entry, where a computing device receives a beacon signal from a second beacon.

FIG. 3C illustrates an embodiment of a system associated with beaconized time entry.

FIG. 3D illustrates an embodiment of a system associated with beaconized time entry, where a computing device receives a beacon signal from a second beacon.

FIG. 3E illustrates an embodiment of a system associated with beaconized time entry, where a computing device receives a beacon signal from a first beacon.

FIG. 4 illustrates an embodiment of a non-transitory computer-readable medium.

FIG. 5 illustrates an embodiment of a computing system configured with the example systems and/or methods disclosed.

FIG. 6 illustrates an embodiment of an integrated business system and an enterprise network in which an embodiment of the invention may be implemented.

FIG. 7 illustrates an embodiment of a multi-tenant distributed computing service platform.

### DETAILED DESCRIPTION

Computerized systems and methods are described herein that provide for beaconized time entry. In particular, a beacon enabled system is employed to determine when a user enters a work site to start working and when the user exits the work site to stop working. The beacon enabled system improves existing technological processes for tracking employee work hours by setting up beacon devices located at different locations at a work site. The beacon devices are configured to transmit beacon signals that are received and evaluated by a computing device, such as a mobile phone of an employee, to determine whether the computing device entered the work site or exited the work site. In this way, the computing device can transmit time entry data to a remote computing system, such as an enterprise resource planning (ERP) system, for tracking when a user of the computing device enters the work site to start working and exits the work site to stop working. Thus, this beacon system improves existing technological processes for tracking employee work hours by solving technical problems relating to errors from manual input of time entries, time entry imprecision where users forget to enter time entries, and requiring employees to carry additional RFID tags.

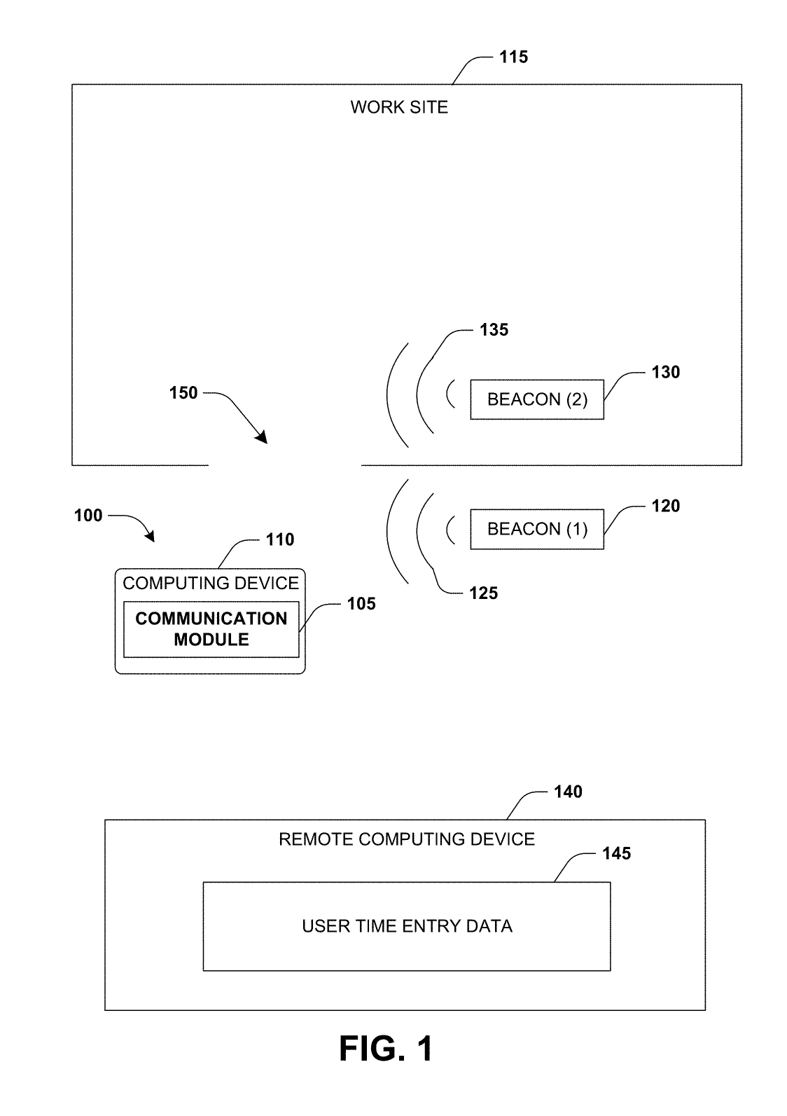

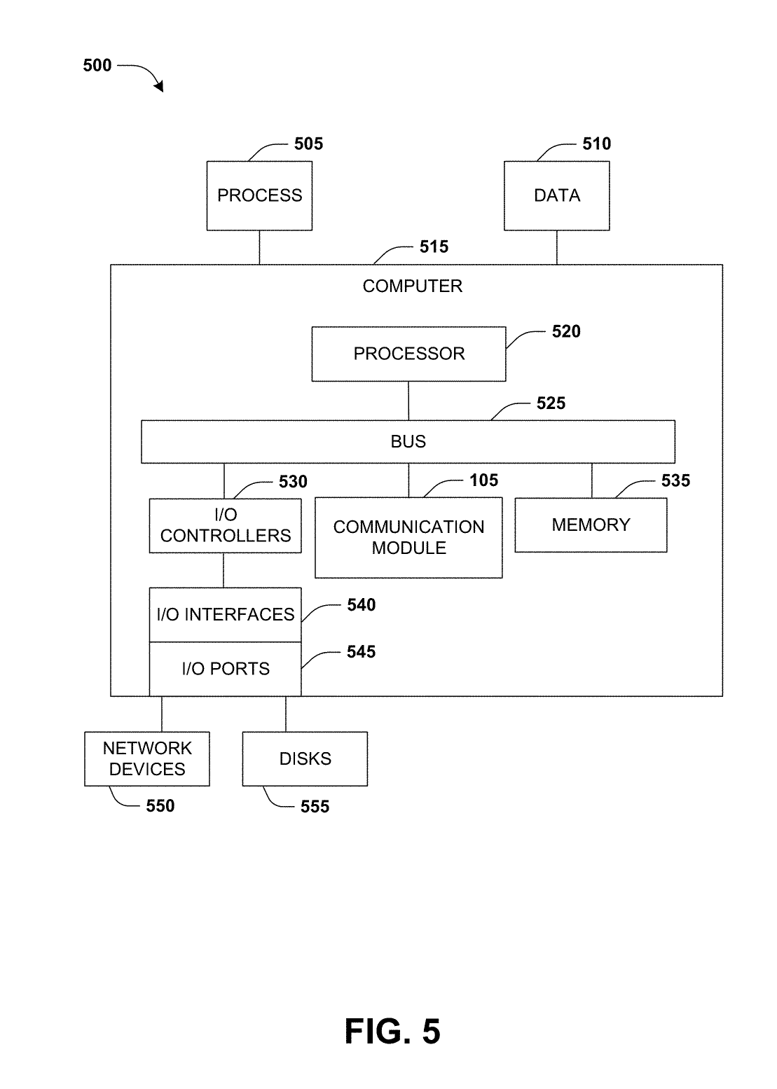

With reference to FIG. 1, one embodiment of a system 100 associated with beaconized time entry is illustrated. The system 100 may be implemented as a communication module 105 hosted on a computing device 110, such as a mobile phone, a tablet, a laptop, a wearable device, or any other computer such as the computer 515 of FIG. 5. The system 100 is configured to operate with beacon devices placed at different locations around a work site 115, such as an office building, a warehouse, a retail store, a construction site, equipment, a vehicle, or any other indoor or outdoor location at which employees can perform work. A beacon device comprises transmitter hardware capable of emitting beacon signals that can be detected by other computing devices, such as the computing device 110. The beacon device can transmit beacon signals that deliver proximity-based and context-aware messages that can be used by receiving devices to identify the beacon device and determine their proximity to the beacon device. Thus, the computing device 110 can “see” the beacon device when the computing device 110 is close enough to the beacon device to receive beacon signals transmitted from the beacon device. The beacon device can be configured to repeatedly transmit beacon signals so that the computing device 110 can detect the beacon device in real time as the computing device 110 moves around the work site 115. In one embodiment, the beacon device can utilize Bluetooth technology to transmit beacon signals so that any computing device with Bluetooth functionality can receive the beacon signals.

In one embodiment, an application on the computing device 110 implements the communication module 105 for communicating with the beacon enabled system. The communication module 105 is configured to control a wireless receiver of the computing device 110 to listen for beacon signals transmitted by beacon devices located at the work site 115. In one embodiment, the wireless receiver is a Bluetooth transceiver. At the work site 115, a beacon device 120 is positioned at a first location at the work site 115. In one embodiment, the beacon device 120 is installed at an entrance 150 to the work site 115, for example on a wall or ceiling at a position that is outside of the entrance 150. The beacon device 120 is configured to emit beacon signals 125, which may comprise a sequence of characters or other data that identify the beacon device 120. In one embodiment, the beacon signals 125 are encoded with a first portion of data comprising a first beacon identifier of the beacon device 120, a second portion of data comprising a site identifier of the work site 115, and/or other information that can be used to determine whether the computing device 110 has entered or exited the work site 115.

A second beacon device 130 is positioned at a second location relative to the work site 115. In one embodiment, the beacon device 130 is installed at the entrance 150 to the work site 115, for example on a wall or ceiling at a position that is offset from the first beacon device 120 (e.g., inside of the entrance 150. The beacon device 130 is configured to emit beacon signals 135, which may comprise a sequence of characters or other data. The beacon signals 135 are encoded with a first portion comprising a second beacon identifier of the beacon device 130, a second portion comprising the site identifier of the work site 115, and/or other information that can be used to determine whether the computing device 110 has entered or exited the work site 115.

The beacon device 120 and the beacon device 130 are positioned relative to one another such that a communication module 105 of the computing device 110 will sequentially detect the different beacon signals. The order in which the beacon devices are detected determines the direction a worker is travelling, which is either entering or exiting the entrance 150. In one embodiment, when the computing device 110 enters the work site 115 (by a worker carrying the computer device 110), the communication module 105, through the wireless receiver, will first receive and detect the beacon signals 125 emitted by the beacon device 120. The communication module 105 determines that the computing device 110 is within communication range of the beacon device 120 based upon receiving the beacon signals 125. As the computing device enters the work site 115 through the entrance 150, the communication module 105, through the wireless receiver, will next receive and detect the beacon signals 135 emitted by the second beacon device 130. The communication module 105 determines that the computing device 110 is within communication range of the beacon device 130 based upon receiving the beacon signals 135.

The communication module 105 can use the beacon identifiers to query a data structure, such as a table, to identify the locations of the beacon devices with respect to one another and the work site 115. The communication module 105 determines whether the computing device 110 entered the work site 115 or exited the work site 115 based upon the sequence of detecting the different beacon signals and the first location of the beacon device 120 relative to the second location of the beacon device 130 with respect to the work site 115, such as the entrance 150. In one embodiment, the communication module 105 determines that the computing device 110 entered the work site 115 because the beacon signals 125 from the beacon device 120 were detected before the beacon signals 135 from the beacon device 130 and because the beacon device 120 is positioned outside of the entrance 150 and the beacon device is positioned inside of the entrance 150. Similarly, the communication module 105 would determine that the computing device 110 exited the work site 115 where the beacon signals 125 from the beacon device 120 were detected after the beacon signals 135 from the beacon device 130 and because the beacon device 120 is positioned outside of the entrance 150 and the beacon device is positioned inside of the entrance 150.

Upon determining that the computing device 110 entered the work site 115, the communication module 105 transmits a first time entry command over a network to a remote computing system 140, such as an ERP system, for updating user time entry data 145. The time entry command may comprise various information, such as a time at which the computing device 110 entered the work site 115, an identifier of the computing device 110, an employee identifier of the employee that is assigned to the computing device 110, etc. The command causes the computing system 140 to generate a time entry for the worker in the user time entry data 145 that represents a work start time, for example.

Similarly, upon determining that the computing device 110 exited the work site 115, the communication module 105 transmits a second time entry command over the network to the remote computing system 140 for updating the user time entry data 145. For example, the second time entry command indicates that the worker exited the work site and thus stopped working. The command causes the computing system 140 to generate a time entry for the worker in the user time entry data 145 that represents a work stop time, for example. During any given day, the worker may enter and exit the work site 115 multiple times. Thus, present system can track the physical presence of the worker using an electronic system operating with the beacon devices 120, 130 and can record more accurate work start and stop times that does not rely on manual inputting of data.

In this way, existing technological processes for tracking employee work time are improved by using the beacon enabled system and the communication module 105 for determining when employees enter and exit work sites. Start and stop time entries are controlled and generated based on a physical presence of the worker (and his/her computing device) relative to the beacon devices 120, 130, which produces more accurate work data. The present system can then avoid or reduce a reliance on manual entry of start and stop times, which are susceptible to error and/or intentional misinformation.

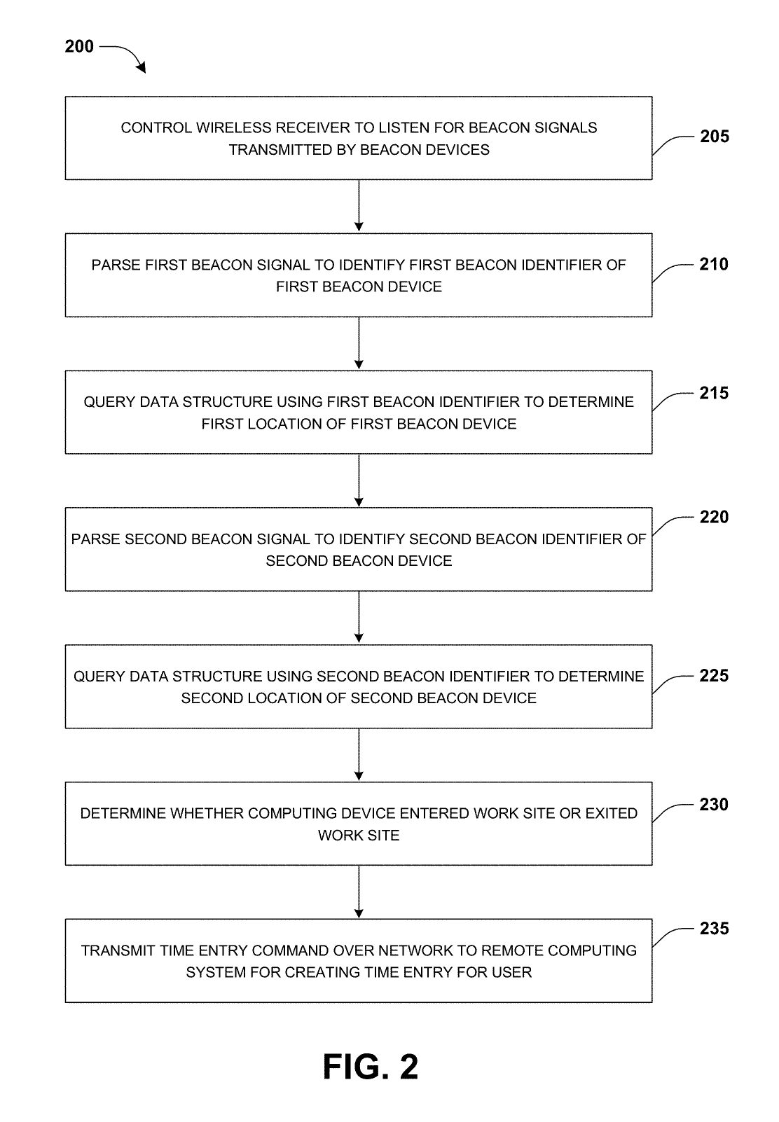

With reference to FIG. 2, one embodiment of a computer implemented method 200 associated with beacon enabled time entry is illustrated. In one embodiment, the method 200 is performed by the communication module 105 utilizing various computing resources of the computer 515 or other computers, such as the processor 520 for executing instructions associated with controlling a wireless receiver, evaluating beacon signals, and transmitting time entry commands. Memory 535 and/or disks 555 are used for storing data structures of beacon device data and/or other data. Network hardware is used for communication of time entry commands and/or other data between the computer 515 and remote computers over a network, such as for transmitting the time entry commands to a remote ERP system. The method 200 is triggered upon execution of an application on the computing device 110 that implements the communication module 105.

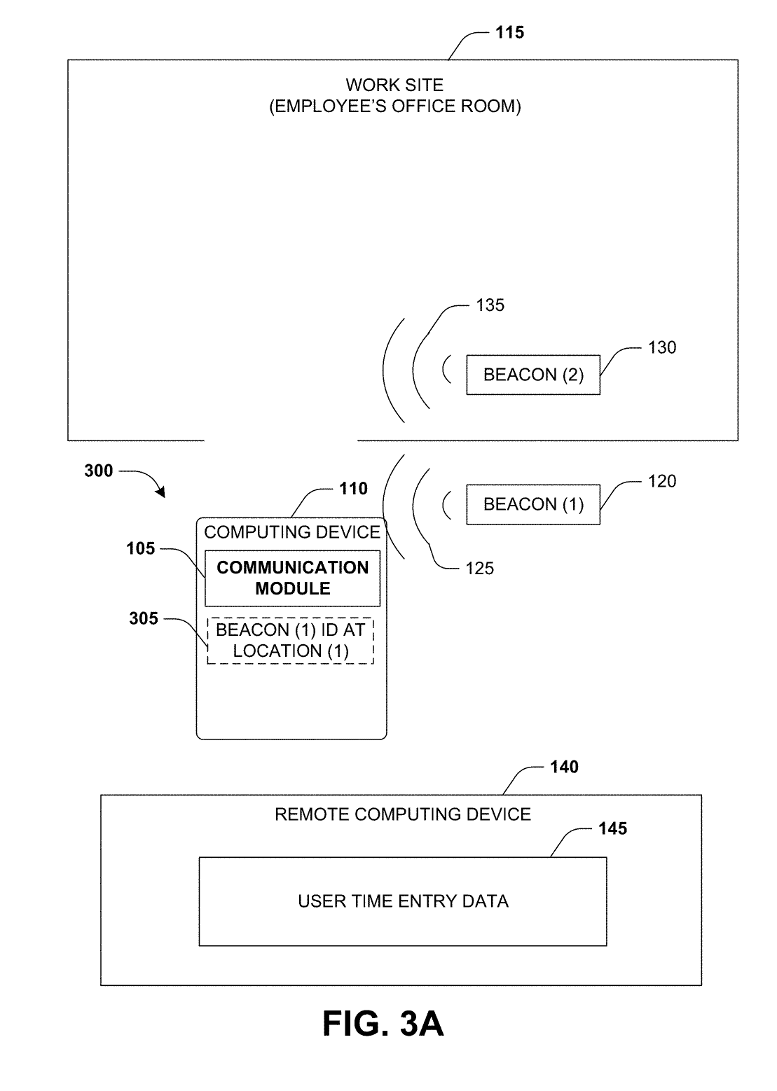

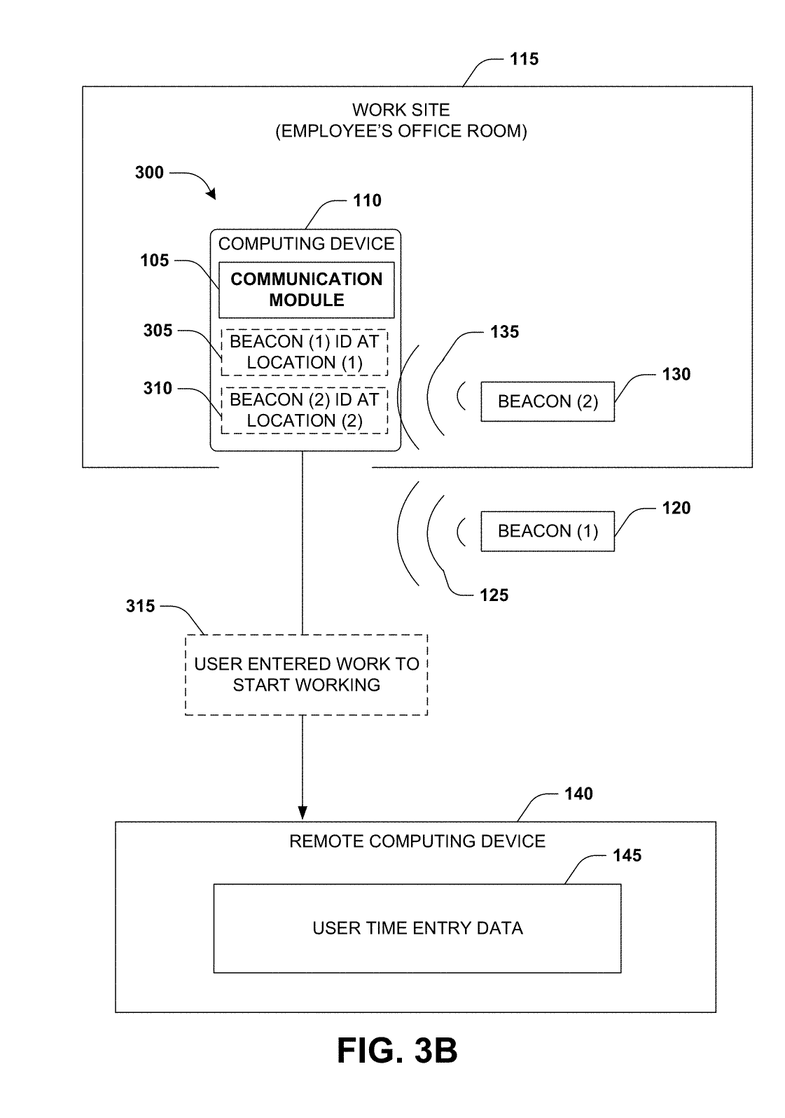

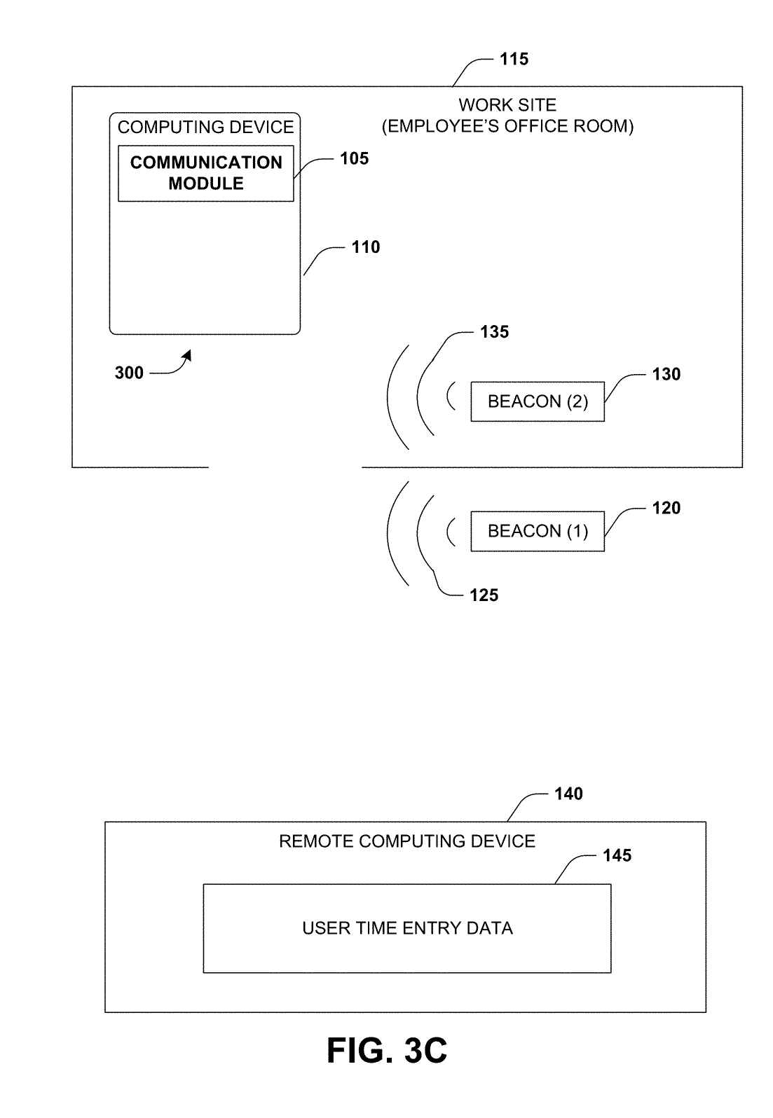

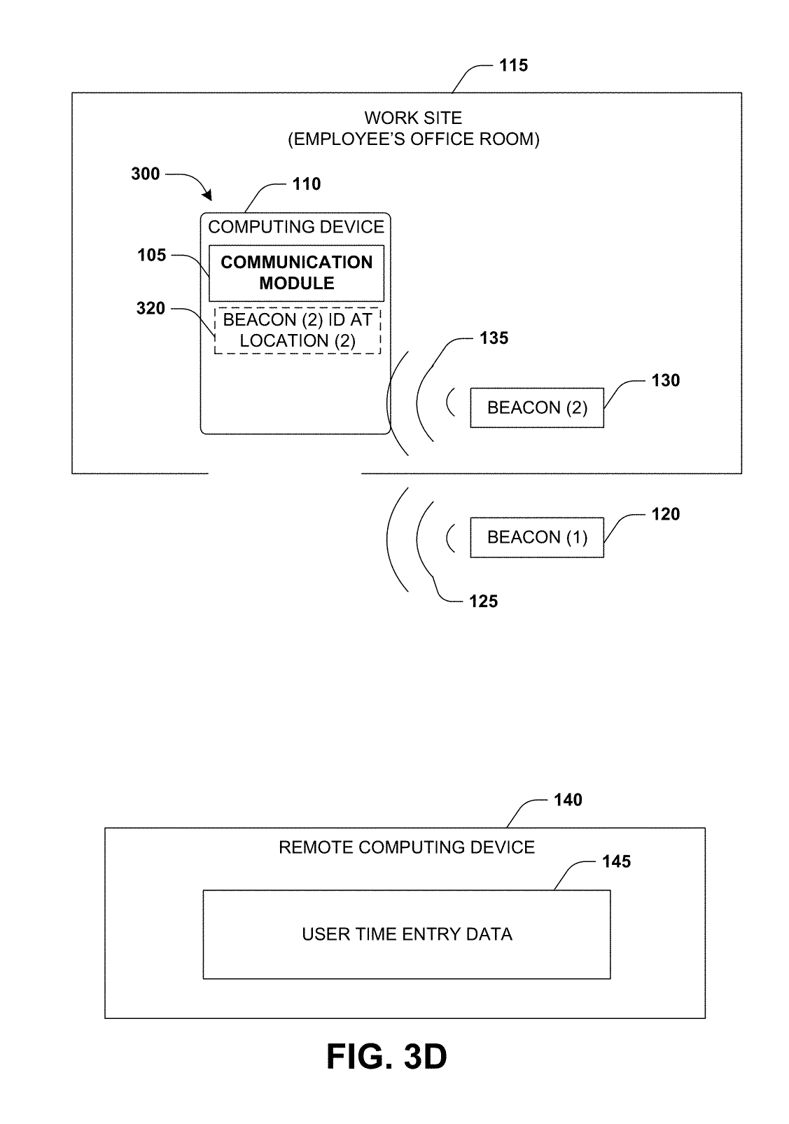

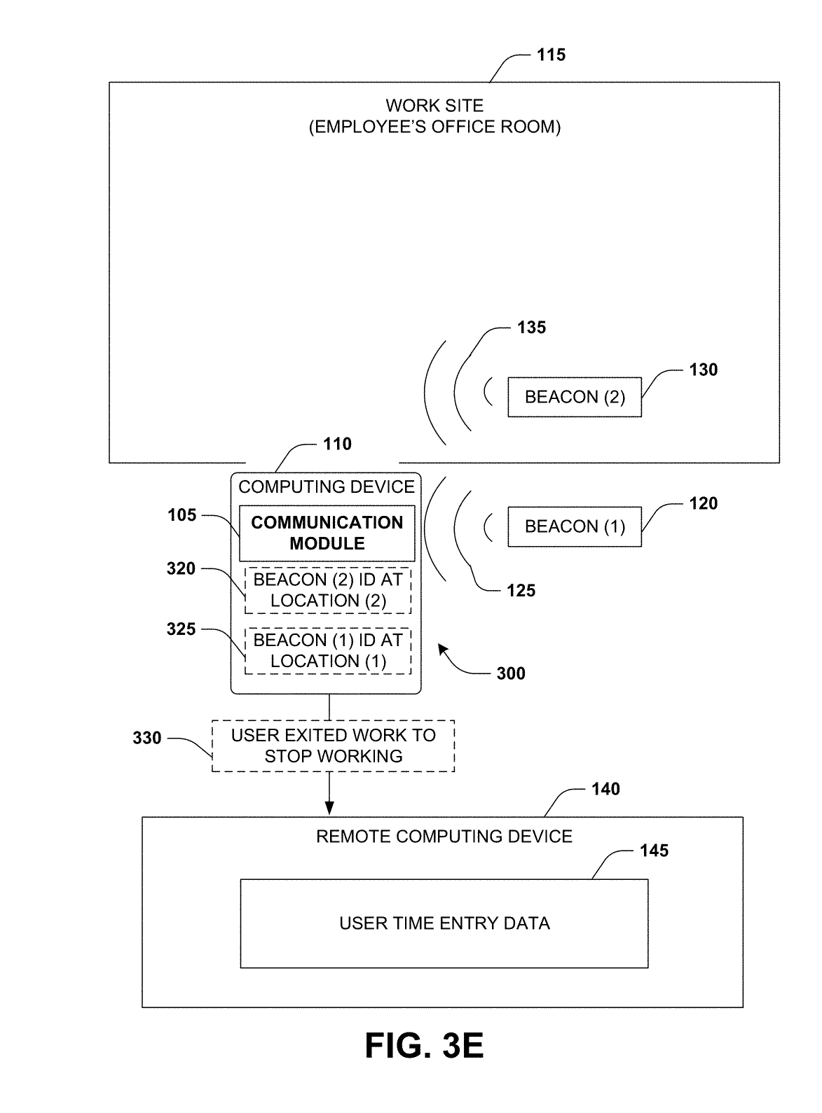

A beacon enabled system is employed at a work site 115, as illustrated by example system 300 of FIG. 3A. In one embodiment, the work site 115 comprises a building. In another embodiment, the work site 115 comprises a room within the building, such as an employee's office. In another embodiment, the work site comprises a company vehicle or other company equipment. In this way, the beacon enabled system can be deployed for various indoor locations, outdoor locations, and/or objects such as vehicles for tracking employee work time. The beacon enabled system can comprise a single beacon device, two beacon devices, or any other number of beacon devices. Beacon devices can be positioned at various locations of the work site 115, such as proximate to an entrance of the building, an entrance of the employee's office, within the company vehicle, etc. Beacon devices can be free standing, attached to or installed within a wall or structure, implemented as a standalone device, incorporated into another device, attached to or installed within a company asset or other object, etc.

In one embodiment of the beacon enabled system, the beacon device 120 is positioned at a first location, such as outside an entrance to an employee's office room. The beacon device 130 is positioned at a second location, such as inside the employee's office room and near the entrance. The beacon device 120 and the beacon device 130 can be positioned at any location such that beacon signals emitted from one of the beacon devices will be detected by the communication module 105 before or after beacon signals emitted from the other beacon device. For example, both beacon devices can be positioned in series inside the entrance of the employee's office room. In this way, the communication module 105 can use the sequence of which beacon signals are detected to determine whether the computing device 110 entered the employee's office room or exited the employee's office room.

In one embodiment, the beacon devices are positioned at a distance from one another so that the beacon signals 125 and the beacon signals 135 do not cause interference. In another embodiment, the beacon devices are positioned at a distance from one another so that the beacon signals 125 and the beacon signals 135 would not both be detected at the same time by the communication 105. In another embodiment, the beacon devices are positioned at a distance from one another so that the beacon signals 125 and the beacon signals 135 could be detected at the same time when the computing device 110 is in certain locations such as between the beacon devices. In one embodiment, signal strengths of the beacon signals 125 and the beacon signals 135 is configured so that the beacon signals 125 and the beacon signals 135 do not cause interference.

The beacon device 120 is configured to emit beacon signals 125 encoded with a first beacon identifier of the beacon device 120 and a site identifier of the work site 115. The beacon device 130 is configured to emit beacon signals 135 encoded with a second beacon identifier of the beacon device 130 and the site identifier of the work site 115. A data structure can be created and populated with information mapping beacon identifiers to locations of beacons and/or other information. In this way, the communication module 105 can query the data structure using beacon identifiers to determine what corresponding beacon device is nearby and the location of that beacon device.

At 205, the communication module 105 controls a wireless receiver of the computing device 110 to listen for beacon signals transmitted by beacon devices located at different locations at the work site 115. In one embodiment, the communication module 105, such as the application executing on the computing device 110, accesses and controls a Bluetooth receiver of the computing device 110 using a Bluetooth driver installed within an operating system of the computing device 110. Commands and functions of the Bluetooth driver can be used by the communication module 105 to obtain beacon signals received by the Bluetooth receiver. In this way, the communication module 105 controls the wireless receiver to receive beacon signals and provide the communication module 105 with access to the received beacon signals.

An employee, carrying the computing device 110, may walk towards the entrance of the employee's office room, as illustrated in FIG. 3A. As the computing device 110 comes within communication range of the beacon device 120, the communication module 105 receives the beacon signals 125 emitted from the beacon device 120. At 210, the communication module 105 parses the beacon signals 125 to identify the first beacon identifier of the beacon device 120. In one embodiment, the beacon signals 125 are received as a sequence of characters or other data that can be parsed using parsing functionality. A first portion of the sequence of characters is parsed to identify the first beacon identifier of the beacon device 120. A second portion of the sequence of characters is parsed to identify the site identifier of the work site 115.

At 215, the data structure mapping beacon identifiers to locations of corresponding beacon devices is queried by the communication module 105 using the first beacon identifier to determine the first location of the beacon device 120. In one embodiment, the first beacon identifier is mapped within the data structure to the first location specifying that the beacon device 120 is located outside of an entrance to the work site 115. The data structure may specify other information for the first beacon identifier, such as an indication that if the beacon signals 125 from the beacon device 120 are detected before the beacon signals 135 of the beacon device 130, then the computing device 110 is entering the work site 115. The data structure may also map site identifiers to work sites. Thus, the communication module 105 can query the data structure using the site identifier to determine that the employee is at the work site 115.

The communication module 105 can also query the data structure using an employee identifier of the employee to determine whether the employee works at the work site 115. In this way, the communication could 105 can determine that the computing device 110 is entering/exiting the work site 115 in order for the user to start working or stop working as opposed to merely entering another work site at which the employee does not work, and thus work time entry should not be recorded. The communication module 105 may store a first entry 305 that the beacon device 120 having the first beacon identifier and located at the first location was detected at a particular point in time.

The employee may enter into the employee's office room through the entrance, as illustrated in FIG. 3B. As the computing device 110 comes within communication range of the beacon device 130, the communication module 105 receives the beacon signals 135 emitted from the beacon device 130. In one embodiment, the communication module 105 may no longer receive the beacon signals 125 from the beacon device 120 because the computing device 110 is not within communication range of the beacon device 120. At 220, the communication module 105 parses the beacon signals 135 to identify the second beacon identifier of the beacon device 130. In one embodiment, the beacon signals 135 are received as a sequence of characters or other data that can be parsed using parsing functionality. A first portion of the sequence of characters is parsed to identify the second beacon identifier of the beacon device 130. A second portion of the sequence of characters is parsed to identify the site identifier of the work site 115.

At 225, the data structure mapping beacon identifiers to locations of corresponding beacon devices is queried by the communication module 105 using the second beacon identifier to determine the second location of the beacon device 130. In one embodiment, the second beacon identifier is mapped within the data structure to the second location specifying that the beacon device 130 is located inside of the entrance to the work site 115. The data structure may specify other information for the second beacon identifier, such as an indication that if the beacon signals 135 from the beacon device 130 are detected after the beacon signals 125 of the beacon device 120, then the computing device 110 is entering the work site 115. The data structure may also map site identifiers to work sites. Thus, the communication module 105 can query the data structure using the site identifier to determine that the employee is at the work site 115.

The communication module 105 can also query the data structure using the employee identifier of the employee to determine whether the employee works at the work site 115. In this way, the communication could 105 can determine that the computing device 110 is entering/exiting the work site 115 in order for the user to start working or stop working as opposed to merely entering another work site at which the employee does not work, and thus work time entry should not be recorded. The communication module 105 may store a second entry 310 that the beacon device 130 having the second beacon identifier and located at the second location was detected at a particular point in time subsequent to when the beacon signals 125 from the beacon device 120 were detected.

At 230, the communication module 105 evaluates the first entry 305 and the second entry 310 to determine whether the computing device 110 entered the work site 115 or exited the work site 115. In particular, the communication module 105 determines the sequence of which the beacon device were encountered based upon the sequence of which the beacon signals 125 and beacon signals 135 were detected. In one embodiment, the first entry 305 indicates that the beacon signals 125 emitted by the beacon device 120 were detected at a first time. The second entry 310 indicates that the beacon signals 135 emitted by the beacon device 130 were detected at a second time subsequent the first time. Thus, the communication module 105 determines that the beacon device 120 was encountered before the beacon device 130.

The communication module 105 evaluates the first location of the beacon device 120 relative to the second location of the beacon device 130. In one embodiment, the communication module 105 evaluates locational information within the first entry 305 and the second entry 310 to determine that the beacon device 120 is located outside of the entrance to the work site 115 and that the beacon device 130 is located inside of the entrance of the work site 115. In this way, the communication module 105 can determine that the computing device 110 entered the work site 115 to start working because the beacon device 120 was encountered before the beacon device 130.

The communication module 105 creates a time entry command 315 based upon the determination that the computing device 110 entered the work site 115. In one embodiment, the time entry command 315 is only created if the computing device 110 remains within the work site 115 a threshold amount of time that is indicative of the employee performing work (e.g., as opposed to merely stopping by to pick up a jacket or to do other non-related work tasks). The communication module 105 creates the time entry command 315 as an instruction that instructs the remote computing system 140, such as the ERP system, to create a time entry for the employee within the user time entry data 145. The time entry command 315 may comprise the employee identifier of the employee, the site identifier of the work site 115, and a time at which the computing device 110 entered the work site 115. The time may correspond to the time at which the beacon signals 125 were detected, the time at which the beacon signals 135 were detected, or some other time derived from the times at which the beacon signals were detected from the beacon devices.

At 235, the communication module 105 transmits the time entry command over a network, such as a wireless network, to the remote computing system 140 for creating a time entry for the employee within the user time entry data 145 to indicate that the employee entered the work site 115 to start working. In one embodiment, the communication module 105 invokes a representational state transfer (REST) application programming interface (API) to transmit the time entry command to the ERP system.

The employee may remain within the employee's office room to work for 4 hours before leaving the employee's office room for lunch, as illustrated in FIG. 3C. The employee, while carrying the computing device 110, may move towards the entrance of the employee's office room in order to exit the employee's office room for lunch, as illustrated in FIG. 3D. As the computing device 110 comes within communication range of the beacon device 130, the communication module 105 receives the beacon signals 135 from the beacon device 130.

The communication module 105 parses the beacon signals 135 to identify the second beacon identifier of the beacon device 130 and the site identifier of the work site 115. The communication module 105 queries the data structure using the second beacon identifier to determine that the computing device 110 has come within communication range of the beacon device 130 positioned at the second location on the inside of the entrance to the work site 115. Accordingly, the communication module 105 creates a third entry 320 specifying that the computing device 110 encountered the beacon device 130 at the second location at a third time.

The employee may walk through the entrance and out of the employee office room, as illustrated in FIG. 3E. As the computing device 110 comes within communication range of the beacon device 120, the communication module 105 receives the beacon signals 125 from the beacon device 120. The communication module 105 parses the beacon signals 125 to identify the first beacon identifier of the beacon device 120 and the site identifier of the work site 115. The communication module 105 queries the data structure using the first beacon identifier to determine that the computing device 110 has come within communication range of the beacon device 120 positioned at the first location on the outside of the entrance to the work site 115. Accordingly, the communication module 105 creates a fourth entry 325 specifying that the computing device 110 encountered the beacon device 130 at the second location at a fourth time.

The communication module 105 creates a second time entry command 330 based upon the determination that the computing device 110 exited the work site 115. In one embodiment, the second time entry command 330 is only created if the computing device 110 remained within the work site 115 a threshold amount of time that is indicative of the employee performing work. The communication module 105 creates the second time entry command 330 as an instruction that instructs the remote computing system 140, such as the ERP system, to create a second time entry for the employee within the user time entry data 145. The second time entry command 330 may comprise the employee identifier of the employee, the site identifier of the work site 115, and a time at which the computing device 110 exited the work site 115. The time may correspond to the time at which the beacon signals 125 were detected, the time at which the beacon signals 135 were detected, or some other time derived from the times at which the beacon signals were detected from the beacon devices.

In one embodiment of beaconized time entry, the communication module 105 does not transmit individual time entry commands for each time the computing devices 110 enters or exits the work site 115. Instead the communication module 105 creates time entries that are locally stored on the computing device 110 until a trigger event causes the communication module 105 to transmit the time entries and/or a total number of hours worked to the remote computing system 140. For example, the communication module 105 receives a plurality of beacon signals from a plurality of beacon devices during a work period, such as a work day or week for the employee. The triggering event may be where a current time corresponds to an end of the work day or week or other timespan. The triggering event could correspond to other triggers such as a current location of the computing device 110 (e.g., the computing device being the employee's home), receipt of a request for time entry data received from the remote computing device 140, etc. The communication module 105 creates a plurality of time entries within a data structure stored within a storage device of the computing device 110. The plurality of time entries specify times at which the employee entered the work site 115 to start working during the work period and exited the work site 115 to stop working during the work period.

The communication module 105 processes the data structure to analyze the time entries to calculate a total number of work hours that the user worked at the work site 115 during the work period. For example, the total number of work hours may be calculate as a sum of time between time entries where the user entered the work site 115 and corresponding subsequent time entries where the user exited the work site 115. The communication module 105 transmits the total number of work hours over the network to the remote computing system 140 for recording a work period time entry for the user within the user time entry data 145. The communication module 105 may also transmit the individual time entries to the remote computing system 140. The communication module 105 may render the total number of work hours and/or the time entries through a display of the computing device 110.

In one embodiment of beaconized time entry, the communication module 105 may render various messages and/or information on the display of the computing device 110 based upon whether the computing device 110 entered or exited the work site 115. In one embodiment, the communication module 105 determines that the computing device 110 entered the work site 115. Accordingly, the communication module 105 queries the ERP system to identify a task for the user to perform at the work site, such as to repair a laptop. In this way, the communication module 105 renders a description of the task on the display of the computing device 110.

In another embodiment, the communication module 105 determines that the computing device 110 entered the work site 115. Accordingly, the communication module 105 queries a message data structure of messages to identify a message mapped to an enter work event (e.g., “good morning”, “welcome back from lunch”, etc.). In this way, the communication module 105 renders the message on the display of the computing device 110.

In another embodiment, the communication module 105 determines that the computing device 110 exited the work site 115. Accordingly, the communication module 105 queries the message data structure of messages to identify a message mapped to an exit work event (e.g., “have a safe commute home”, “enjoy your evening”, etc.). In this way, the communication module 105 renders the message on the display of the computing device 110.

In another embodiment, the communication module 105 identifies a current date. Accordingly, the communication module 105 evaluates a user profile of the employee, which may be maintained by the ERP system, to identify an event associated with the user for the current date. The event can correspond to a task assigned to the user, a celebration, a work anniversary, a birthday event, a co-worker's birthday, a food day at work, a dress down day at work, or any other event related to the employee, the work site, other employees, etc. The message data structure is queried using the event to identify a message mapped to the event. In this way, the communication module 105 renders the message on the display of the computing device 110. Similarly, the communication module 105 can query the ERP system to identify an event occurring at the work site 115, such as a visitor visiting, a project meeting, a planned fire drill, etc. The communication module 105 renders information about the event on the display of the computing device 110.

In another embodiment, the communication module 105 determines that the computing device 110 exited the work site 115 and that a current time is a lunch time for the employee. Accordingly, the communication module 105 queries the message data structure of messages to identify a message mapping to a lunch restaurant suggestion. In this way, the communication module 105 renders the lunch restaurant suggestion on the display of the computing device 110.

In another embodiment, the communication module 105 determines that the computing device 110 exited the work site. Accordingly, the communication module 105 queries the user profile to identify a home location of the user. The communication module 105 queries a traffic service to identify traffic information associated with a commute of the user to the home location. In this way, the communication module 105 renders the traffic information on the display of the computing device 110. The communication module 105 may also render a map user interface populated with the traffic information and a route from the work site 115 to the home location in response to determining that the computing device 110 exited the work site 115.

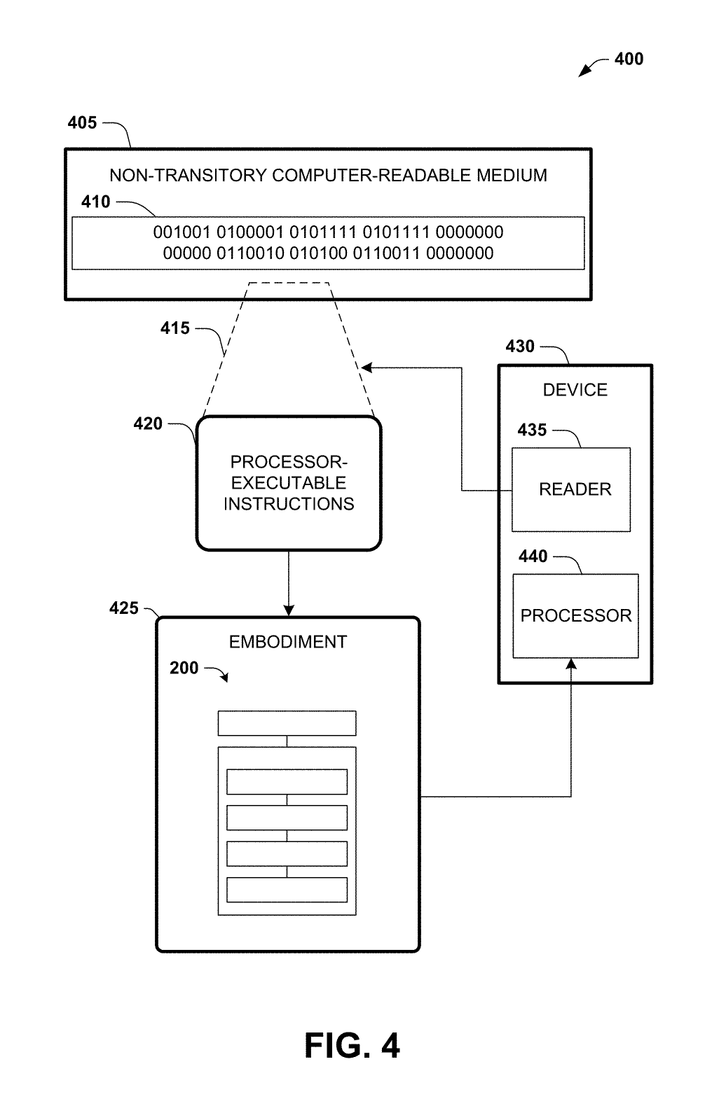

FIG. 4 is an illustration of a scenario 400 involving an example non-transitory computer-readable medium 405. In one embodiment, one or more of the components described herein are configured as program modules, such as the communication module 105, stored in the non-transitory computer-readable medium 405. The program modules are configured with stored instructions, such as processor-executable instructions 420, that when executed by at least a processor, such as processor 440, cause the computing device to perform the corresponding function(s) as described herein. In one embodiment, the, functionality of the communication module 105, stored in the non-transitory computer-readable medium 405, may be executed by the processor 440 as the processor-executable instructions 420 to perform an embodiment 425 of the method 200 of FIG. 2.

The non-transitory computer-readable medium 405 includes the processor-executable instructions 420 that when executed by a processor 440 cause performance of at least some of the provisions herein. The non-transitory computer-readable medium 405 includes a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory computer-readable medium 405 stores computer-readable data 410 that, when subjected to reading 415 by a reader 435 of a device 430 (e.g., a read head of a hard disk drive, or a read operation invoked on a solid-state storage device), express the processor-executable instructions 420.

In some embodiments, the processor-executable instructions 420, when executed cause performance of operations, such as at least some of the example method 200 of FIG. 2, for example. In some embodiments, the processor-executable instructions 420 are configured to cause implementation of a system, such as at least some of the example system 100 of FIG. 1, for example.

FIG. 5 illustrates an example computing device 500 that is configured and/or programmed with one or more of the example systems and methods described herein, and/or equivalents. The example computing device 500 may be the computer 515 that includes a processor 520, a memory 535, and I/O ports 545 operably connected by a bus 525. In one embodiment, the, the computer 515 may include logic of the communication module 105 configured to facilitate the system 100 and/or the method 200 shown in FIGS. 1-2. In different embodiments, the logic of the communication module 105 may be implemented in hardware, a non-transitory computer-readable medium 505 with stored instructions, firmware, and/or combinations thereof. While the logic of the communication module 105 is illustrated as a hardware component attached to the bus 525, it is to be appreciated that in other embodiments, the logic of the communication module 105 could be implemented in the processor 520, stored in memory 535, or stored in disk 555.

In one embodiment, logic of the communication module 105 or the computer 515 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 515 as data 510 that are temporarily stored in memory 535 and then executed by processor 520.

The logic of the communication module 105 may also provide means (e.g., hardware, non-transitory computer-readable medium 505 that stores executable instructions, firmware) for performing rule based source sequencing for allocation.

Generally describing an example configuration of the computer 515, the processor 520 may be a variety of various processors including dual microprocessor and other multi-processor architectures. The memory 535 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 555 may be operably connected to the computer 515 via, for example, the I/O interface 540 (e.g., card, device) and the I/O ports 545. The disks 555 may be, for example, a magnetic disk drive, a solid state disk drive, a floppy disk drive, a tape drive, a Zip drive, a flash memory card, a memory stick, and so on. Furthermore, the disks 555 may be a CD-ROM drive, a CD-R drive, a CD-RW drive, a DVD ROM, and so on. The memory 535 can store a process, such as within the non-transitory computer-readable medium 505, and/or data 510, for example. The disk 555 and/or the memory 535 can store an operating system that controls and allocates resources of the computer 515.

The computer 515 may interact with input/output (I/O) devices via the I/O interfaces 540 and the I/O ports 545. The I/O devices may be, for example, a keyboard, a microphone, a pointing and selection device, cameras, video cards, displays, the disks 555, the network devices 550, and so on. The I/O ports 545 may include, for example, serial ports, parallel ports, and USB ports. I/O controllers 530 may connect the I/O interfaces 540 to the bus 525.

The computer 515 can operate in a network environment and thus may be connected to the network devices 550 via the I/O interfaces 540, and/or the I/O ports 545. Through the network devices 550, the computer 515 may interact with a network. Through the network, the computer 515 may be logically connected to remote computers (e.g., the computer 515 may reside within a distributed computing environment to which clients may connect). Networks with which the computer 515 may interact include, but are not limited to, a local area network (LAN), a new area network (WAN), and other networks.

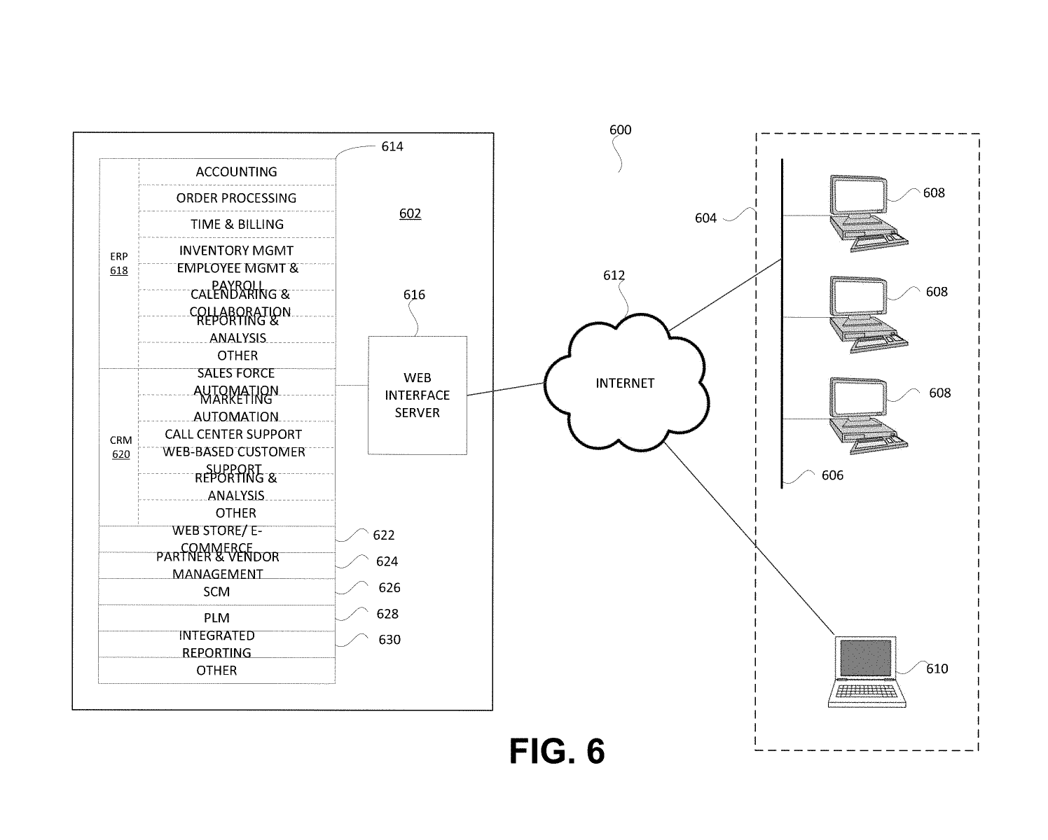

FIG. 6 is a diagram illustrating a system 600 in which an embodiment of the invention may be implemented. Enterprise network 604 may be associated with a business enterprise, such as a retailer, merchant, service provider, or other type of business. Alternatively, and in accordance with the advantages of an application service provider (ASP) hosted integrated business system (such as a multi-tenant data processing platform), the business enterprise may comprise fewer or no dedicated facilities or business network at all, provided that its end users have access to an internet browser and an internet connection.

For simplicity and clarity of explanation, the enterprise network 604 is represented by an on-site local area network 606 to which a plurality of personal computers 608 are connected, each generally dedicated to a particular end user, such as a service agent or other employee (although such dedication is not required), along with an exemplary remote user computer 610 that can be, for example, a laptop computer or tablet computer of a traveling employee having internet access through a public Wi-Fi access point, or other internet access method. The end users (consumers) associated with computers 608 and 610 may possess an internet-enabled smartphone or other electronic device (such as a PDA, tablet, laptop computer) having wireless internet access or other synchronization capabilities. Users of the enterprise network 604 interface with the integrated business system 602 across the Internet 612 or another suitable communications network or combination of networks.

Integrated business system 602, which may be hosted by a dedicated third party, may include an integrated business server 614 and a web interface server 616, coupled as shown in FIG. 6. It is to be appreciated that either or both of the integrated business server 614 and the web interface server 616 may be implemented on one or more different hardware systems and components, even though represented as singular units in FIG. 6.

In a typical example in which system 602 is operated by a third party for the benefit of multiple account owners/tenants, each of whom is operating a business, integrated business server 614 comprises an ERP module 618 and further comprises a CRM module 620. In many cases, it will be desirable for the ERP module 618 to share methods, libraries, databases, subroutines, variables, etc., with CRM module 620, and indeed ERP module 618 may be intertwined with CRM module 620 into an integrated Business Data Processing Platform (which may be single tenant, but is typically multi-tenant).

The ERP module 618 may include, but is not limited to, a finance and accounting module, an order processing module, a time and billing module, an inventory management and distribution module, an employee management and payroll module, a calendaring and collaboration module, a reporting and communication module, and other ERP-related modules. The CRM module 620 may include, but is not limited to, a sales force automation (SFA) module, a marketing automation module, a contact list module (not shown), a call center support module, a web-based customer support module, a reporting and communication module, and other CRM-related modules.

The integrated business server 614 (or multi-tenant data processing platform) further may provide other business functionalities including a web store/eCommerce module 622, a partner and vendor management module 624, and an integrated reporting module 630. An SCM (supply chain management) module 626 and PLM (product lifecycle management) module 628 may also be provided. Web interface server 616 is configured and adapted to interface with the integrated business server 614 to provide one or more web-based user interfaces to end users of the enterprise network 604.

The integrated business system shown in FIG. 6 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet or a private “intranet” network. The server, and the services it provides, may be referred to as the “host” and the remote computers, and the software applications running on the remote computers, being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

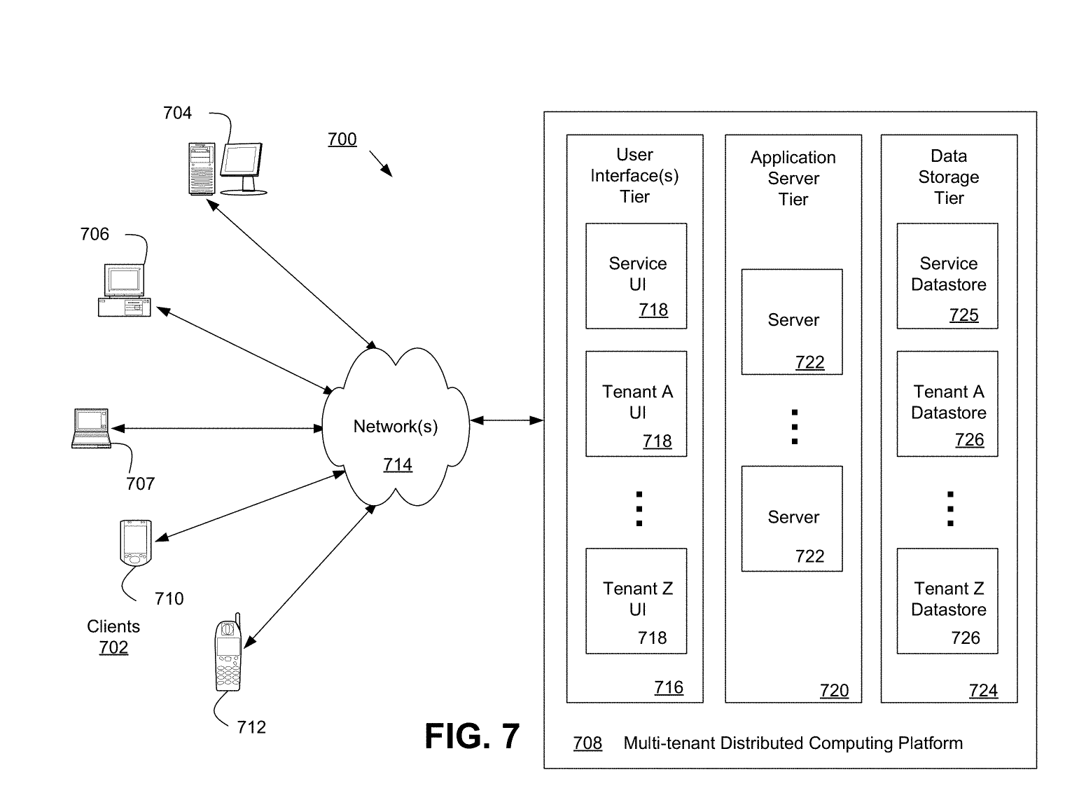

FIG. 7 is a diagram illustrating elements or components of an example operating environment 700 in which an embodiment of the invention may be implemented. As shown, a variety of clients 702 incorporating and/or incorporated into a variety of computing devices may communicate with a distributed computing service/platform 708 through one or more networks 714. For example, a client may incorporate and/or be incorporated into a client application (e.g., software) implemented at least in part by one or more of the computing devices.

Examples of suitable computing devices include personal computers, server computers 704, desktop computers 706, laptop computers 708, notebook computers, tablet computers or personal digital assistants (PDAs) 710, smart phones 712, cell phones, and consumer electronic devices incorporating one or more computing device components, such as one or more electronic processors, microprocessors, central processing units (CPU), or controllers. Examples of suitable networks 714 include networks utilizing wired and/or wireless communication technologies and networks operating in accordance with any suitable networking and/or communication protocol (e.g., the Internet). In use cases involving the delivery of customer support services, the computing devices noted represent the endpoint of the customer support delivery process, i.e., the consumer's device.

The distributed computing service/platform (which may also be referred to as a multi-tenant business data processing platform) 708 may include multiple processing tiers, including a user interface tier 716, an application server tier 720, and a data storage tier 724. The user interface tier 716 may maintain multiple user interfaces 718, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 724 may include one or more data stores, which may include a Service Data store 725 and one or more Tenant Data stores 726.

Each tenant data store 726 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 708 may be multi-tenant and service platform 708 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 722 that are part of the platform's Application Server Tier 720.

Another business information system that may be provided as part of an integrated data processing and service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions.

In addition to ERP and CRM functions, a business information system/platform (such as element 708 of FIG. 7(A)) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system. Such functions or business applications are typically implemented by one or more modules of software code/instructions that are maintained on and executed by one or more servers 722 that are part of the platform's Application Server Tier 720.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform (such as platform 708 of FIG. 7).

As noted with regards to FIG. 6, the integrated business system shown in FIG. 7 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet or a private “intranet” network.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users. Some of those multiple users may have distinct roles or responsibilities within the business or entity.

In some cases, a tenant may desire to modify or supplement the functionality of an existing platform application by introducing an extension to that application, where the extension is to be made available to the tenant's employees and/or customers. In some cases, such an extension may be applied to the processing of the tenant's business related data that is resident on the platform. The extension may be developed by the tenant or by a 3rd party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as functionality associated with an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension. Further, the developer may wish to upgrade or provide a patch to the extension as they recognize a need for fixes or additional functionality that would be beneficial to incorporate into the extension. In some cases, the developer may prefer to make the upgrade available to only a select set of users (at least initially) in order to obtain feedback for improving the newer version of the extension, to test the stability of the extension, or to assist them to segment the market for their extension(s).

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“U se r”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that when executed by a processor of a computing device causes the processor to:
control a wireless receiver of the computing device to listen for beacon signals transmitted by beacon devices located at different locations at a work site;
in response to receiving, by the wireless receiver, a first beacon signal from a first beacon device located at the work site:
(i) parse the first beacon signal to identify a first beacon identifier of the first beacon device; and
(ii) query, using the first beacon identifier, a data structure mapping beacon identifiers to locations of corresponding beacon devices to determine a first location of the first beacon device;
in response to receiving, by the wireless receiver, a second beacon signal from a second beacon device located at the work site:
(i) parse the second beacon signal to identify a second beacon identifier of the second beacon device; and
(ii) query, using the second beacon identifier, the data structure to determine a second location of the second beacon device;
determine whether the computing device entered the work site or exited the work site based upon the first location relative to the second location and a sequence of which the first beacon signal and the second beacon signal were received; and
transmit a time entry command over a network to a remote computing system for creating a time entry for a user of the computing device based upon the time entry command, wherein the time entry command indicates whether the user entered the work site to start working or exited the work site to stop working.

2. The non-transitory computer-readable medium of claim 1, wherein the instructions comprise instructions to:
in response to receiving a plurality of beacon signals from a plurality of beacon devices during a work period:
create a plurality of time entries within a data structure stored within a storage device of the computing device, wherein the plurality of time entries specify times at which the user entered the work site to start working during the work period and exited the work site to stop working during the work period.

3. The non-transitory computer-readable medium of claim 2, wherein the instructions comprise instructions to:
process the data structure to calculate a total number of work hours that the user worked at the work site during the work period; and
transmit the total number of work hours over the network to the remote computing system for recording a work day time entry for the user.

4. The non-transitory computer-readable medium of claim 1, wherein the first beacon device is positioned at the first location that is closer to an entry for the work site than the second location of the second beacon device.

5. The non-transitory computer-readable medium of claim 1, wherein the instructions comprise instructions to:
in response to determining that the computing device entered the work site:
query a message data structure of messages to identify a message mapped to an enter work event; and
render the message on a display of the computing device; and
in response to determining that the computing device exited the work site:
query the message data structure of messages to identify a message mapped to an exit work event; and
render the message on the display of the computing device.

6. The non-transitory computer-readable medium of claim 1, wherein the instructions comprise instructions to:
determine a current date;
evaluate a user profile of the user to identify an event associated with the user for the current date;
query a message data structure of messages to identify a message mapped to the event; and
render the message on a display of the computing device.

7. The non-transitory computer-readable medium of claim 1, wherein the instructions comprise instructions to:
invoke a representational state transfer (REST) application programming interface (API) to transmit the time entry command to an enterprise resource planning (ERP) system hosted by the remote computing system.

8. The non-transitory computer-readable medium of claim 1, wherein the instructions comprise instructions to:
parse a first portion of the first beacon signal to identify the first beacon identifier of the first beacon device and a second portion of the first beacon signal to identify a site identifier of the work site;
utilize the site identifier to determine that the computing device is at the work site; and
utilize the first location of the first beacon device and the second location of the second beacon device to determine that a sequence where the first beacon device is encountered before the second beacon device is indicative of the computing device entering the work site.

9. The non-transitory computer-readable medium of claim 1, wherein the instructions comprise instructions to:
parse a first portion of the first beacon signal to identify the first beacon identifier of the first beacon device and a second portion of the first beacon signal to identify a site identifier of the work site;
utilize the site identifier to determine that the computing device is at the work site; and
utilize the first location of the first beacon device and the second location of the second beacon device to determine that a sequence where the first beacon is encountered before the second beacon is indicative of the computing device exiting the work site.

10. A computing system, comprising:
a processor connected to memory; and
a communication module stored on a non-transitory computer readable medium and configured with instructions that when executed by the processor cause the processor to:
control a wireless receiver of a computing device to listen for beacon signals transmitted by beacon devices located at different locations at a work site;
in response to receiving, by the wireless receiver, a first beacon signal from a first beacon device located at the work site:
(i) parse the first beacon signal to identify a first beacon identifier of the first beacon device; and
(ii) query, using the first beacon identifier, a data structure mapping beacon identifiers to locations of corresponding beacon devices to determine a first location of the first beacon device;
in response to receiving, by the wireless receiver, a second beacon signal from a second beacon device located at the work site:
(i) parse the second beacon signal to identify a second beacon identifier of the second beacon device; and
(ii) query, using the second beacon identifier, the data structure to determine a second location of the second beacon device;
determine whether the computing device entered the work site or exited the work site based upon the first location relative to the second location and a sequence of which the first beacon signal and the second beacon signal were received; and
transmit a time entry command over a network to a remote computing system for creating a time entry for a user of the computing device based upon the time entry command, wherein the time entry command indicates whether the user entered the work site to start working or exited the work site to stop working.

11. The computing system of claim 10, wherein the instructions comprise instructions that cause the processor to:
determine that a current time is a lunch time for the user;
determine that the computing device exited the work site during the lunch time;
query a message data structure of messages to identify a message mapped to a lunch restaurant suggestion; and
render the message on a display of the computing device.

12. The computing system of claim 10, wherein the instructions comprise instructions that cause the processor to:
evaluate a user profile of the user to determine that a current date is a birthday of the user;
query a message data structure of messages to identify a message mapped to a birthday event; and
render the message on a display of the computing device.

13. The computing system of claim 10, wherein the instructions comprise instructions that cause the processor to:
determine that the computing device exited the work site;
query a user profile to identify a home location of the user;
query a traffic service to identify traffic information associated with a commute of the user to the home location; and
render the traffic information on a display of the computing device.

14. The computing system of claim 13, wherein the instructions to render the traffic information comprise instructions that cause the processor to:
render, on the display of the computing device, a map user interface populated with the traffic information and a route from the work site to the home location.

15. A computer-implemented method, the computer-implemented method involving a computing device comprising a processor, and the computer-implemented method comprising:
controlling, by the processor, a wireless receiver of the computing device to listen for beacon signals transmitted by beacon devices located at different locations at a work site;
in response to receiving, by the wireless receiver, a first beacon signal from a first beacon device located at the work site:
(i) parsing, by the processor, the first beacon signal to identify a first beacon identifier of the first beacon device; and
(ii) querying, by the processor using the first beacon identifier, a data structure mapping beacon identifiers to locations of corresponding beacon devices to determine a first location of the first beacon device;
in response to receiving, by the wireless receiver, a second beacon signal from a second beacon device located at the work site:
(i) parsing, by the processor, the second beacon signal to identify a second beacon identifier of the second beacon device; and
(ii) querying, by the processor using the second beacon identifier, the data structure to determine a second location of the second beacon device;
determining, by the processor, whether the computing device entered the work site or exited the work site based upon the first location relative to the second location and a sequence of which the first beacon signal and the second beacon signal were received; and
transmitting, by the processor, a time entry command over a network to a remote computing system for creating a time entry for a user of the computing device based upon the time entry command, wherein the time entry command indicates whether the user entered the work site to start working or exited the work site to stop working.

16. The computer-implemented method of claim 15, further comprising:
determining that the computing device entered the work site;
querying an enterprise resource planning system hosted by the remote computing system to identify a task for the user to perform at the work site; and
rendering a description of the task on a display of the computing device.

17. The computer-implemented method of claim 15, further comprising:
in response to receiving a plurality of beacon signals from a plurality of beacon devices during a work period:
creating a plurality of time entries within a data structure stored within a storage device of the computing device, wherein the plurality of time entries specify times at which the user entered the work site to start working during the work period and exited the work site to stop working during the work period.

18. The computer-implemented method of claim 17, further comprising:
processing the data structure to calculate a total number of work hours that the user worked at the work site during the work period; and
transmitting the total number of work hours over the network to the remote computing system for recording a work day time entry for the user.

19. The computer-implemented method of claim 18, further comprising:
rendering the total number of work hours on a display of the computing device.

20. The computer-implemented method of claim 15, further comprising:
querying an enterprise resource planning system hosted by the remote computing system to identify an event occurring at the work site; and
rendering information about the event on a display of the computing device.
